(19) United States
(12) Patent Application Publication
(10) Pub. No.: US 2025/0334454 A1
(43) Pub. Date: Oct. 30, 2025

(54) CONDUCTIVE MODULE AND TEMPERATURE MEASURING DEVICE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Masato Tanaka, Makinohara-shi (JP)

(21) Appl. No.: 19/186,569

(22) Filed: Apr. 22, 2025

(30) Foreign Application Priority Data
Apr. 24, 2024 (JP) 2024-070457

(51) Int. Cl. G01K 1/143; G01K 7/22; H01M 10/48; H01M 50/298; H01M 50/507

(52) U.S. Cl. CPC G01K 1/143; H01M 10/486; H01M 50/298; H01M 50/507; G01K 7/22

(57) ABSTRACT

A thermistor holder includes: a base portion disposed to face a restraint member; and thermistor holding bodies. A thermistor holding body includes: an insertion hole formed in the base portion and into which a thermistor is to be inserted; a thermistor housing portion that cylindrically protrudes from a peripheral edge portion of the insertion hole and that is to be inserted into a locking hole of the restraint member; a first locking portion that protrudes from the peripheral edge portion of the insertion hole in each of cutouts and that locks a claw portion inserted into the locking hole to a peripheral edge portion of the locking hole and holds the claw portion to the restraint member; and a pair of second locking portions that protrude from the peripheral edge portion of the insertion hole in a direction opposite to the thermistor housing portion and lock the thermistor.

### CROSS-REFERENCE TO RELATED APPLICATION(S)

The present application claims priority to and incorporates by reference the entire contents of Japanese Patent Application No. 2024-070457 filed in Japan on Apr. 24, 2024.

### BACKGROUND OF THE INVENTION

### 1. Field of the Invention

The present invention relates to a conductive module and a temperature measuring device.

### 2. Description of the Related Art

A conductive module electrically connects a plurality of battery cells by using a plurality of bus bars in a battery module in which the plurality of battery cells is arranged. Then, the conductive module electrically connects the bus bars to a battery monitoring unit that monitors the battery state of the battery cells by using a wiring component such as an electric wire. For example, JP 2020-119 651 A discloses this type of conductive module.

Incidentally, a battery monitoring unit monitors the temperature of a battery cell as one of the battery states of a monitoring target. Therefore, a thermistor that detects the surface temperature of a battery cell is installed in a battery module. The thermistor needs to be kept in contact with the surface of the battery cell in order to enhance the stability of a temperature measurement result. Simplifying an operation of installation to the battery module is required while ensuring a function of holding the contact state.

### SUMMARY OF THE INVENTION

Thus, an object of the present invention is to provide a conductive module and a temperature measuring device capable of both simplifying an operation of installing a thermistor and stabilizing a temperature measurement result.

In order to achieve the above mentioned object, a conductive module according to one aspect of the present invention includes a bus bar to be physically and electrically connected to an electrode terminal of a battery cell constituting a battery module; a wiring component that electrically connects the bus bar to a battery monitoring unit that monitors a battery state of the battery cell; a thermistor that detects a surface temperature of the battery cell with a temperature measuring unit brought into contact with the battery cell; and a housing member that houses the bus bar, the wiring component, and the thermistor, wherein the housing member includes: a bus bar housing tool in which a bus bar housing chamber that houses the bus bar is provided for each of a plurality of the bus bars and the wiring component is routed, and the bus bar housing tool is held by the battery module; and a thermistor holder that holds the thermistor, the thermistor holder includes: a base portion disposed to face a restraint member for a plurality of the battery cells constituting the battery module; and a thermistor holding body that is provided on the base portion and that holds the thermistor, the thermistor holding body includes: an insertion hole which is formed in the base portion and into which the thermistor is to be inserted; a thermistor housing portion provided with a pair of cutouts that cylindrically protrude from a peripheral edge portion of the insertion hole to a side of the restraint member, that are to be inserted into a locking hole having a through-hole shape or a cutout-hole shape provided in the restraint member, and that are disposed to face each other in a direction orthogonal to a cylinder axis; a first locking portion that protrudes from the peripheral edge portion of the insertion hole in each of the cutouts, that locks a claw portion inserted into the locking hole to a peripheral edge portion of the locking hole and holds the claw portion to the restraint member with the bus bar housing tool being held by the battery module; and a pair of second locking portions that protrude from the peripheral edge portion of the insertion hole in a direction opposite to the thermistor housing portion and that lock the thermistor housed in the thermistor housing portion, and the thermistor includes a locked portion that presses the temperature measuring unit protruding from the thermistor housing portion against a surface of the battery cell by protruding for each of the second locking portions, being disposed closer to a side of the insertion hole than a claw portion of each of the second locking portions at a housing completion position in the thermistor housing portion, and being locked to the claw portion of each of the second locking portions at the housing completion position.

In order to achieve the above mentioned object, a temperature measuring device according to another aspect of the present invention includes a thermistor that detects a surface temperature of a battery cell constituting a battery module with a temperature measuring unit brought into contact with the battery cell; and a thermistor holder that holds the thermistor, wherein the thermistor holder includes: a base portion disposed to face a restraint member for a plurality of the battery cells constituting the battery module; and a thermistor holding body that is provided on the base portion and that holds the thermistor, the thermistor holding body includes: an insertion hole which is formed in the base portion and into which the thermistor is to be inserted; a thermistor housing portion provided with a pair of cutouts that cylindrically protrude from a peripheral edge portion of the insertion hole to a side of the restraint member, that are to be inserted into a locking hole having a through-hole shape or a cutout-hole shape provided in the restraint member, and that are disposed to face each other in a direction orthogonal to a cylinder axis; a first locking portion that protrudes from the peripheral edge portion of the insertion hole in each of the cutouts, that locks a claw portion inserted into the locking hole to a peripheral edge portion of the locking hole and holds the claw portion to the restraint member; and a pair of second locking portions that protrude from the peripheral edge portion of the insertion hole in a direction opposite to the thermistor housing portion and that lock the thermistor housed in the thermistor housing portion, and the thermistor includes a locked portion that presses the temperature measuring unit protruding from the thermistor housing portion against a surface of the battery cell by protruding for each of the second locking portions, being disposed closer to a side of the insertion hole than a claw portion of each of the second locking portions at a housing completion position in the thermistor housing portion, and being locked to the claw portion of each of the second locking portions at the housing completion position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a conductive module and a temperature measuring device according to an embodiment;

FIG. 2 is an exploded perspective view partially illustrating the side of the temperature measuring device;

FIG. 3 is a partial cross-sectional view illustrating the side of the temperature measuring device; and

FIG. 4 is a partial cross-sectional view illustrating the side of the temperature measuring device.

### DETAILED DESCRIPTION OF THE PREFERRED EMBODIMENTS

An embodiment of a conductive module and a temperature measuring device according to the present invention will be described in detail below with reference to the drawings. Note that the invention is not limited by the embodiment.

### EMBODIMENT

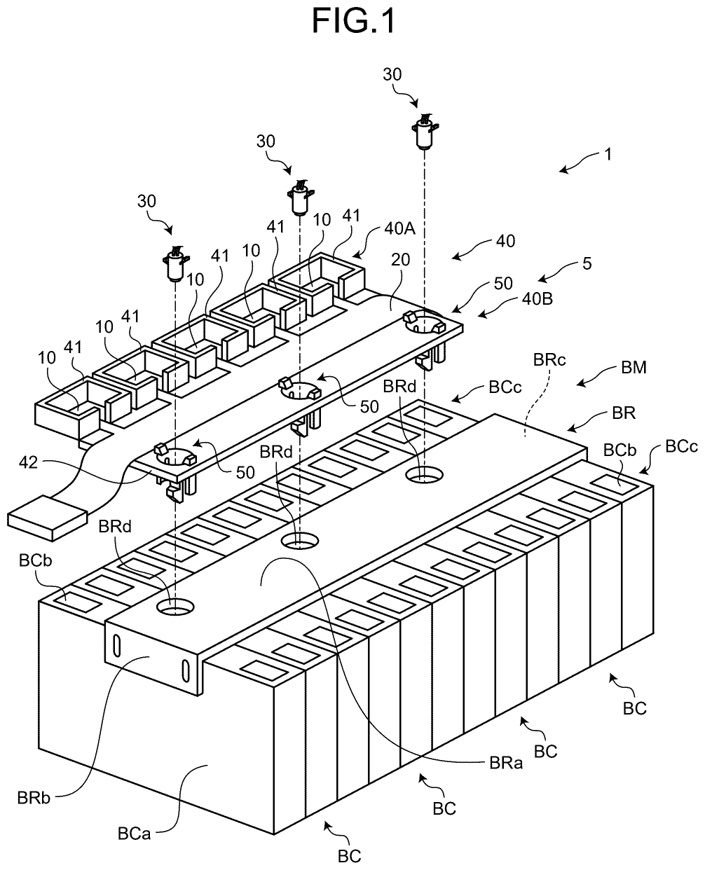

One of embodiments of a conductive module and a temperature measuring device according to the present invention will be described with reference to FIGS. 1 to 4.

Reference numeral 1 in FIGS. 1 to 4 denotes a conductive module of the embodiment. “The conductive module 1 is assembled to a battery module BM (FIG. 1) in which a plurality of battery cells BC is arranged (e.g., arranged in one row), and electrically connects the plurality of battery cells BC in the battery module BM to each other. Furthermore, the conductive module 1 electrically connects the battery module BM to a battery monitoring unit (not illustrated) to cause the battery monitoring unit to monitor the battery states of the battery cells BC. The conductive module 1 constitutes a battery pack together with the battery module BM. The battery pack is mounted on, for example, a vehicle (e.g., battery electric vehicle (BEV) and hybrid electric vehicle (HEV)) including a rotary machine as a drive source, and is used to supply power to the rotary machine.

A battery cell BC includes a cell body BCa and positive and negative electrode terminals BCb (FIG. 1). In the battery cell BC here, the cell body BCa has a rectangular parallelepiped shape having six outer wall surfaces. Then, in the plurality of battery cells BC constituting the battery module BM, cell bodies BCa adjacent to each other in the arrangement direction are arranged such that one outer wall surface of a cell body BCa faces the other outer wall surface of the other cell body BCa. The battery module BM includes one electrode terminal group BCc and the other electrode terminal group BCc (FIG. 1). In one electrode terminal group BCc, electrode terminals BCb on one side in the battery cells BC are arranged along the arrangement direction. In the other electrode terminal group BCc, electrode terminals BCb on the other side in the battery cells BC are arranged along the arrangement direction.

The “arrangement direction” mentioned below without a particular note refers to an arrangement direction of the plurality of battery cells BC and an arrangement direction of the pluralities of electrode terminals BCb in the electrode terminal groups BCc.

In this example, each of the battery cells BC includes positive and negative electrode terminals BCb on one of the six outer wall surfaces of the cell body BCa (FIG. 1). Therefore, in the battery module BM, the two electrode terminal groups BCc are provided on one plane (FIG. 1).

The battery module BM includes a restraint member BR that restrains and fixes the plurality of battery cells BC in the arrangement state (FIG. 1). The restraint member BR is formed of a metal material or a synthetic resin material.

The restraint member BR includes a flat-plate-shaped flat plate portion BRa disposed between the two electrode terminal groups BCc and extending between a battery cell BC disposed at one end in the arrangement direction and a battery cell BC disposed at the other end in the arrangement direction (FIG. 1). The flat plate portion BRa has a rectangular flat plate shape.

Furthermore, the restraint member BR includes a first locking portion BRb and a second locking portion BRc (FIG. 1). The first locking portion BRb is suspended from one end in the extending direction in the flat plate portion BRa, is disposed to face a side surface of the battery cell BC disposed at one end in the arrangement direction, and performs locking. The second locking portion BRc is suspended from the other end in the extending direction in the flat plate portion BRa, is disposed to face a side surface of the battery cell BC disposed at the other end in the arrangement direction, and performs locking. For example, the first locking portion BRb and the second locking portion BRc of the restraint member BR are fixed to the side surfaces of the battery cells BC.

Furthermore, an electrode terminal BCb here has a flat plate shape. A bus bar 10 to be described later is physically and electrically connected to the electrode terminal BCb by welding and the like (FIG. 1). Note, however, that the electrode terminal BCb may have an electrode pole shape including a male screw portion. In this case, the bus bar 10 is screwed and fixed to the electrode terminal BCb by screwing a female screw member to the male screw portion of the electrode terminal BCb.

The conductive module 1 includes the bus bar 10 to be physically and electrically connected to the electrode terminal BCb of the battery cell BC constituting the battery module BM (FIG. 1). The bus bar 10 is formed of a conductive material such as metal. The bus bar 10 is a plate-shaped conductive component made of metal. The bus bar 10 is press-formed by using a metal plate as a base material, for example.

For example, the conductive module 1 includes, as bus bars 10, those to be physically and electrically connected to a pair of adjacent electrode terminals BCb of the battery cell BC in the battery module BM, those to be physically and electrically connected to electrode terminals BCb serving as total negative electrodes in the battery module BM, and those to be physically and electrically connected to electrode terminals BCb serving as total positive electrodes in the battery module BM.

The conductive module 1 includes a wiring component 20 that electrically connects the bus bar 10 to the battery monitoring unit (FIG. 1). The wiring component 20 may be an electric wire provided for each of the bus bars 10, or may be, for example, a flexible printed circuit (FPC) board including a conductor for each of the bus bars 10.

The conductive module 1 includes thermistors 30 that detect the surface temperatures of the battery cells BC (FIGS. 1 to 4).

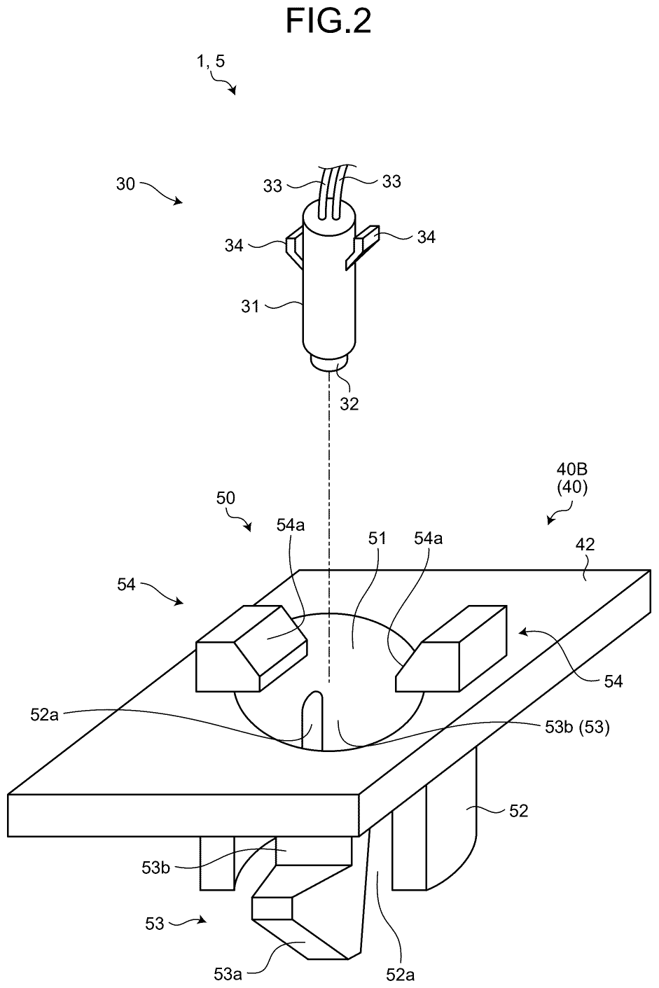

A thermistor 30 includes a columnar main body 31 and a temperature measuring unit 32 provided at an end of the main body 31 (FIGS. 2 to 4). The thermistor 30 detects the surface temperature of a battery cell BC with the temperature measuring unit 32 brought into contact with the battery cell BC. Furthermore, the thermistor 30 is provided with two electric wires 33 to be electrically connected to the battery monitoring unit (FIGS. 2 to 4). Note that the thermistor 30 may include, for example, a flexible printed circuit (FPC) board or a flexible flat cable (FFC) instead of the two electric wires 33. The thermistor 30 here includes the columnar main body 31. Then, the conductive module 1 here includes a plurality of thermistors 30.

The conductive module 1 includes a housing member 40 that houses the bus bars 10, the wiring component 20, and the thermistors 30 (FIGS. 1 to 4). The housing member 40 is formed of an insulating material such as synthetic resin.

The housing member 40 includes a bus bar housing tool 40A (FIG. 1). In the bus bar housing tool 40A, the bus bar housing chambers 41 that house a bus bar 10 are provided for the plurality of bus bars 10, and the wiring component 20 is routed. The bus bar housing tool 40A is held by the battery module BM. Furthermore, the housing member 40 includes a thermistor holder 40B that holds the thermistors 30 (FIGS. 1 to 4). The housing member 40 here is one member formed by integrating the bus bar housing tool 40A and the thermistor holder 40B. Note, however, that the housing member 40 may include the bus bar housing tool 40A and the thermistor holder 40B, which have been formed as individual members, and a coupling mechanism (not illustrated) that couples the bus bar housing tool 40A with the thermistor holder 40B.

The thermistor holder 40B includes a base portion 42 disposed to face the restraint member BR (FIGS. 1 to 4). The base portion 42 extends between one end and the other end in the extending direction of the flat plate portion BRa of the restraint member BR, and is disposed to face the flat plate portion BRa. The base portion 42 here has a rectangular flat plate shape.

Furthermore, the thermistor holder 40B includes thermistor holding bodies 50 that are provided on the base portion 42 and that hold the thermistor 30 (FIGS. 1 to 4). The thermistor holder 40B is provided with the thermistor holding bodies 50 for the thermistors 30.

A thermistor holding body 50 has an insertion hole 51 (FIGS. 2 to 4). The insertion hole 51 is formed in the base portion 42. The thermistor 30 is inserted into the insertion hole 51. The insertion hole 51 is a circular through hole that matches the shape of the main body 31 of the thermistor 30.

Furthermore, the thermistor holding body 50 includes a thermistor housing portion 52 cylindrically protruding from a peripheral edge portion of the insertion hole 51 to the side of the restraint member BR (FIGS. 2 to 4). The thermistor housing portion 52 cylindrically protrudes to the side of the flat plate portion BRa of the restraint member BR. In the flat plate portion BRa of the restraint member BR, locking holes BRd having a through-hole shape or a cutout-hole shape are formed at positions facing the insertion holes 51 (FIGS. 1, 3, and 4). Here, the locking holes BRd having a circular through-hole shape are formed for the thermistor holding bodies 50. The thermistor housing portion 52 is inserted into a locking hole BRd of the restraint member BR.

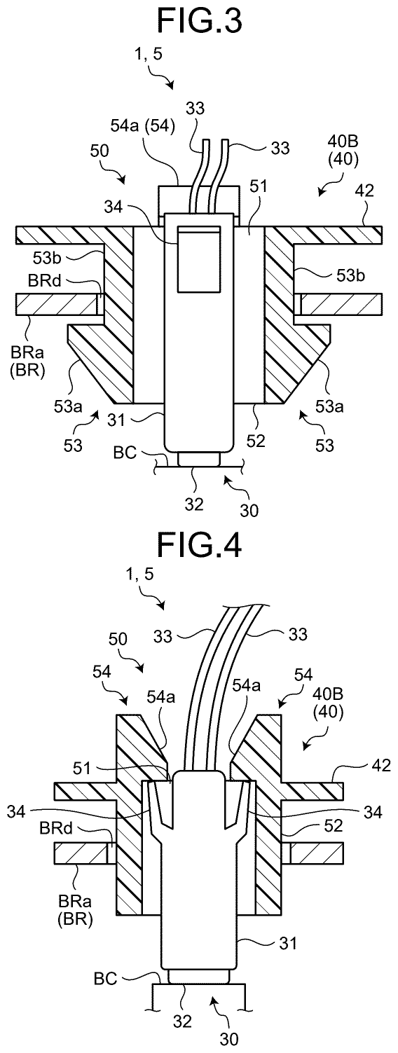

The thermistor housing portion 52 is provided with a pair of cutouts 52a disposed to face each other in a direction orthogonal to the cylinder axis (FIG. 2). The thermistor holding body 50 includes first locking portions 53 (FIGS. 2 and 3). The first locking portions 53 protrude from the peripheral edge portion of the insertion hole 51 in the cutouts 52a. The first locking portions 53 lock claw portions 53a inserted into the locking hole BRd to the peripheral edge portion of the locking hole BRd, and hold the claw portions 53a to the restraint member BR with the bus bar housing tool 40A being held by the battery module BM (FIGS. 2 and 3). A first locking portion 53 includes a cantilevered flexible piece portion 53b bendable and deformable in the radial direction of the thermistor housing portion 52. A claw portion 53a protrudes outward in the radial direction of the thermistor housing portion 52 at a free end of the flexible piece portion 53b (FIGS. 2 and 3).

In the thermistor holding body 50, when the bus bar housing tool 40A is held by the battery module BM, the thermistor housing portion 52 and the pair of first locking portions 53 are inserted into the locking hole BRd of the restraint member BR. In the case, in the first locking portion 53, the claw portion 53a receives force from the peripheral edge portion of the locking hole BRd to bend and deform the flexible piece portion 53b inward in the radial direction. When the claw portion 53a comes out of the locking hole BRd, the bending deformation of the flexible piece portion 53b is eliminated. Accordingly, the claw portion 53a can be caught by the peripheral edge portion of the locking hole BRd. When the thermistor housing portion 52 is about to be detached from the locking holes BRd, the claw portion 53a is locked to the peripheral edge portion of the locking hole BRd. This causes the thermistor holding body 50 to be held by the restraint member BR, and causes the thermistor holder 40B to be held by the restraint member BR.

Furthermore, the thermistor holding body 50 includes a pair of second locking portions 54 (FIGS. 2 to 4). The pair of second locking portions 54 protrude from the peripheral edge portion of the insertion hole 51 in a direction opposite to the thermistor housing portion 52, and lock the thermistor 30 housed in the thermistor housing portion 52 (FIGS. 2 to 4). The pair of second locking portions 54 are disposed to face each other in a direction orthogonal to the cylinder axis of the thermistor housing portion 52. The second locking portions 54 have claw portions 54a that protrude toward the counterpart second locking portions 54 facing each other and that partially cover an outer peripheral portion of the insertion hole 51 (FIGS. 2 to 4). Therefore, the distance between the claw portions 54a of the pair of second locking portions 54 is larger than the main body 31 of the thermistor 30.

The thermistor 30 presses the temperature measuring unit 32 against the surface of the battery cell BC by being locked by the claw portions 54a of the second locking portions 54 from the side of the insertion hole 51 at a housing completion position in the thermistor housing portion 52. Thus, the thermistor 30 includes locked portions 34 to be locked to the claw portions 54a of the second locking portions 54 at the housing completion position (FIGS. 2 to 4). The locked portions 34 protrude for the second locking portions 54. Then, the locked portions 34 press the temperature measuring unit 32 protruding from the thermistor housing portion 52 against the surface of the battery cell BC by being disposed closer to the side of the insertion hole 51 than the claw portions 54a of the second locking portions 54 at the housing completion position in the thermistor housing portion 52 and being locked to the claw portions 54a of the second locking portions 54 at the housing completion position.

Here, the locked portions 34 may protrude from, for example, the outer peripheral wall surface of the main body 31 of the thermistor 30, or may be formed as a part of a member made of synthetic resin different from the thermistor 30 and provided as a part of the thermistor 30 by assembling the member to the main body 31. Here, the locked portions 34 made of synthetic resin are illustrated. The locked portions 34 protrude in a piece shape from the outer peripheral wall surface of the main body 31.

One of the locked portions 34 and the second locking portions 54 is made elastically deformable, and force generated by the elastic deformation is used to press the temperature measuring unit 32 against the surface of the battery cell BC between the thermistor 30 and the thermistor holding body 50.

For example, the locked portions 34 are formed as elastically deformable elastic deformation portions. The locked portions 34 are locked to the second locking portions 54 and elastically deformed with the temperature measuring unit 32 being in contact with the surface of the battery cell BC. The locked portions 34 receive, from the second locking portions 54, reaction force of pressing force acting on the second locking portions 54 accompanying the elastic deformation. The locked portions 34 press the temperature measuring unit 32 against the surface of the battery cell BC.

Furthermore, for example, the second locking portions 54 are formed as elastically deformable elastic deformation portions. A second locking portion 54 in this case includes a cantilevered flexible piece portion bendable and deformable in the radial direction of the thermistor housing portion 52. A claw portion 54a protrudes inward in the radial direction of the thermistor housing portion 52 at a free end of the flexible piece portion (not illustrated). The second locking portion 54 locks locked portions 34 and is elastically deformed with the temperature measuring unit 32 being in contact with the surface of the battery cell BC. The second locking portion 54 presses the temperature measuring unit 32 against the surface of the battery cell BC by causing reaction force accompanying the elastic deformation to act on the locked portions 34.

Incidentally, the thermistor 30 includes the electric wire 33 and the like as described above. The electric wire 33 and the like need to be drawn to the side of the battery monitoring unit. For example, when the electric wire 33 and the like are disposed along the restraint member BR, the electric wire 33 and the like need to fix a holder such as a clip to the restraint member BR. In this case, however, a through hole for fixing the holder needs to be separately provided in the restraint member BR, which is unpreferable in maintaining the strength of the restraint member BR. Thus, the thermistor holder 40B may be provided with a holding portion that holds the electric wire 33 and the like on a routing path (not illustrated).

As described above, the conductive module 1 of the embodiment is obtained by combining the thermistor 30 and the thermistor holder 40B with the bus bar 10, the bus bar housing tool 40A, or the like corresponding to a conventional conductive module. In such a conductive module 1, the side of the thermistor holder 40B to which the thermistor 30 is attached can be assembled to the restraint member BR simultaneously with an assembling operation to the battery module BM on the side of the bus bar housing tool 40A. Then, the conductive module 1 can press the temperature measuring unit 32 of the thermistor 30 against the surface of the battery cell BC only by assembling the side of the thermistor holder 40B to the restraint member BR. Therefore, the conductive module 1 of the embodiment can simplify an operation of installing the thermistor 30.

Furthermore, the conductive module 1 of the embodiment can press the temperature measuring unit 32 of the thermistor 30 against the surface of the battery cell BC by locking a locked portion 34 of the thermistor 30 to the second locking portion 54 of the thermistor holding body 50. Therefore, since the conductive module 1 of the embodiment can keep the state of contact between the temperature measuring unit 32 and the battery cell BC, a temperature measurement result from the thermistor 30 can be stabilized.

For example, the conductive module 1 of the embodiment makes one of the locked portions 34 and the second locking portions 54 elastically deformable. Force generated by the elastic deformation is used to press the temperature measuring unit 32 against the surface of the battery cell BC. Therefore, since the conductive module 1 can keep the state of contact between the temperature measuring unit 32 and the battery cell BC by the force, a temperature measurement result from the thermistor 30 can be stabilized.

Moreover, the conductive module 1 can absorb various tolerance variations such as the dimensional tolerance variation of the thermistor 30, the dimensional tolerance variation of the housing member 40, and the assembling tolerance variations of the thermistor 30 and the housing member 40, and press the temperature measuring unit 32 against the surface of the battery cell BC. The conductive module 1 can thereby stabilize a temperature measurement result from the thermistor 30.

Furthermore, in the conductive module 1 of the embodiment, the thermistor 30 is disposed between the two electrode terminal groups BCc. Here, in the battery module BM, air stays in the space between the two electrode terminal groups BCc. Therefore, the conductive module 1 of the embodiment detects the surface temperature of the battery cell BC in the space where the air stays, so that an error in the temperature measurement result from the thermistor 30 at the time when an environmental temperature in a battery pack changes can be minimized. Therefore, the conductive module 1 of the embodiment can stabilize the temperature measurement result from the thermistor 30 also in this respect.

As described above, the conductive module 1 of the embodiment can both simplify an operation of installing the thermistor 30 and stabilize a temperature measurement result.

Here, when the thermistor holder 40B is formed as a member different from the bus bar housing tool 40A, a temperature measuring device 5 including the thermistor holder 40B and the thermistor 30 can be configured (FIGS. 1 to 4). In this case, one including the bus bar 10, the wiring component 20, and the bus bar housing tool 40A can be defined as a conductive module.

The temperature measuring device 5 can press the temperature measuring unit 32 of the thermistor 30 against the surface of the battery cell BC only by being assembled to the restraint member BR. Therefore, the temperature measuring device 5 can simplify the operation of installing the thermistor 30. Then, the temperature measuring device 5 can exhibit effects similar to the above-described effects of the conductive module 1. Therefore, the temperature measuring device 5 can both simplify an operation of installing the thermistor 30 and stabilize a temperature measurement result.

A conductive module according to the present embodiment is obtained by combining a thermistor and a thermistor holder with a bus bar, a bus bar housing tool, or the like corresponding to a conventional conductive module. In such a conductive module, the side of the thermistor holder to which the thermistor is attached can be assembled to a restraint member simultaneously with an assembling operation to a battery module on the side of the bus bar housing tool. Then, the conductive module can press a temperature measuring unit of the thermistor against the surface of a battery cell only by assembling the side of the thermistor holder to the restraint member. Therefore, the conductive module according to the present embodiment can simplify an operation of installing the thermistor. In contrast, the temperature measuring device according to the present embodiment can press the temperature measuring unit of the thermistor against the surface of the battery cell only by being assembled to the restraint member. Therefore, the temperature measuring device according to the present embodiment can simplify the operation of installing the thermistor.

Furthermore, the conductive module and the temperature measuring device according to the present embodiment can press the temperature measuring unit of the thermistor against the surface of the battery cell by locking a locked portion of the thermistor to a second locking portion of a thermistor holding body. Therefore, since the conductive module and the temperature measuring device according to the present embodiment can keep the state of contact between the temperature measuring unit and the battery cell, a temperature measurement result from the thermistor can be stabilized.

As described above, the conductive module and the temperature measuring device according to the present embodiment can both simplify an operation of installing the thermistor and stabilize a temperature measurement result.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar to be physically and electrically connected to an electrode terminal of a battery cell constituting a battery module;
a wiring component that electrically connects the bus bar to a battery monitoring unit that monitors a battery state of the battery cell;
a thermistor that detects a surface temperature of the battery cell with a temperature measuring unit brought into contact with the battery cell; and
a housing member that houses the bus bar, the wiring component, and the thermistor, wherein
the housing member includes: a bus bar housing tool in which a bus bar housing chamber that houses the bus bar is provided for each of a plurality of the bus bars and the wiring component is routed, and the bus bar housing tool is held by the battery module; and
a thermistor holder that holds the thermistor,
the thermistor holder includes: a base portion disposed to face a restraint member for a plurality of the battery cells constituting the battery module; and
a thermistor holding body that is provided on the base portion and that holds the thermistor,
the thermistor holding body includes: an insertion hole which is formed in the base portion and into which the thermistor is to be inserted;
a thermistor housing portion provided with a pair of cutouts that cylindrically protrude from a peripheral edge portion of the insertion hole to a side of the restraint member, that are to be inserted into a locking hole having a through-hole shape or a cutout-hole shape provided in the restraint member, and that are disposed to face each other in a direction orthogonal to a cylinder axis;
a first locking portion that protrudes from the peripheral edge portion of the insertion hole in each of the cutouts, that locks a claw portion inserted into the locking hole to a peripheral edge portion of the locking hole and holds the claw portion to the restraint member with the bus bar housing tool being held by the battery module; and
a pair of second locking portions that protrude from the peripheral edge portion of the insertion hole in a direction opposite to the thermistor housing portion and that lock the thermistor housed in the thermistor housing portion, and
the thermistor includes a locked portion that presses the temperature measuring unit protruding from the thermistor housing portion against a surface of the battery cell by protruding for each of the second locking portions, being disposed closer to a side of the insertion hole than a claw portion of each of the second locking portions at a housing completion position in the thermistor housing portion, and being locked to the claw portion of each of the second locking portions at the housing completion position.

2. The conductive module according to claim 1, wherein
the locked portion is formed as an elastically deformable elastic deformation portion, is locked to each of the second locking portions and elastically deformed with the temperature measuring unit being in contact with a surface of the battery cell, receives, from each of the second locking portions, reaction force of pressing force acting on each of the second locking portions accompanying elastic deformation, and presses the temperature measuring unit against the surface of the battery cell.

3. The conductive module according to claim 1, wherein
each of the second locking portions is formed as an elastically deformable elastic deformation portion, locks the locked portion and is elastically deformed with the temperature measuring unit being in contact with a surface of the battery cell, and presses the temperature measuring unit against the surface of the battery cell by causing reaction force accompanying elastic deformation to act on the locked portion.

4. The conductive module according to claim 1, further comprising:
a plurality of the thermistors, wherein
the thermistor holder is provided with the thermistor holding body for each of the thermistors.

5. The conductive module according to claim 2, further comprising:
a plurality of the thermistors, wherein
the thermistor holder is provided with the thermistor holding body for each of the thermistors.

6. The conductive module according to claim 3, further comprising:
a plurality of the thermistors, wherein
the thermistor holder is provided with the thermistor holding body for each of the thermistors.

7. The conductive module according to claim 1, wherein
the housing member is one member formed by integrating the bus bar housing tool and the thermistor holder.

8. The conductive module according to claim 2, wherein
the housing member is one member formed by integrating the bus bar housing tool and the thermistor holder.

9. The conductive module according to claim 3, wherein
the housing member is one member formed by integrating the bus bar housing tool and the thermistor holder.

10. The conductive module according to claim 1, wherein
the housing member includes the bus bar housing tool and the thermistor holder which have been formed as individual members, and a coupling mechanism that couples the bus bar housing tool with the thermistor holder.

11. The conductive module according to claim 2, wherein
the housing member includes the bus bar housing tool and the thermistor holder which have been formed as individual members, and a coupling mechanism that couples the bus bar housing tool with the thermistor holder.

12. The conductive module according to claim 3, wherein
the housing member includes the bus bar housing tool and the thermistor holder which have been formed as individual members, and a coupling mechanism that couples the bus bar housing tool with the thermistor holder.

13. A temperature measuring device comprising:
a thermistor that detects a surface temperature of a battery cell constituting a battery module with a temperature measuring unit brought into contact with the battery cell; and
a thermistor holder that holds the thermistor, wherein
the thermistor holder includes: a base portion disposed to face a restraint member for a plurality of the battery cells constituting the battery module; and
a thermistor holding body that is provided on the base portion and that holds the thermistor,
the thermistor holding body includes: an insertion hole which is formed in the base portion and into which the thermistor is to be inserted;
a thermistor housing portion provided with a pair of cutouts that cylindrically protrude from a peripheral edge portion of the insertion hole to a side of the restraint member, that are to be inserted into a locking hole having a through-hole shape or a cutout-hole shape provided in the restraint member, and that are disposed to face each other in a direction orthogonal to a cylinder axis;
a first locking portion that protrudes from the peripheral edge portion of the insertion hole in each of the cutouts, that locks a claw portion inserted into the locking hole to a peripheral edge portion of the locking hole and holds the claw portion to the restraint member; and
a pair of second locking portions that protrude from the peripheral edge portion of the insertion hole in a direction opposite to the thermistor housing portion and that lock the thermistor housed in the thermistor housing portion, and
the thermistor includes a locked portion that presses the temperature measuring unit protruding from the thermistor housing portion against a surface of the battery cell by protruding for each of the second locking portions, being disposed closer to a side of the insertion hole than a claw portion of each of the second locking portions at a housing completion position in the thermistor housing portion, and being locked to the claw portion of each of the second locking portions at the housing completion position.
